(19) United States
(12) Patent Application Publication
(10) Pub. No.: US 2014/0154924 A1
(43) Pub. Date: Jun. 5, 2014

(54) CONDUCTIVE PLATE AND AN ELECTRONIC DEVICE HAVING THE SAME

(71) Applicant: BIONIME CORPORATION, Taichung City (TW)

(72) Inventors: Chun-Mu Huang, Taichung City (TW); Chieh-Hsing Chen, Taichung City (TW); Hsi-Wen Huang, Taichung City (TW)

(73) Assignee: BIONIME CORPORATION, Taicgung City (TW)

(21) Appl. No.: 13/890,913

(22) Filed: May 9, 2013

(30) Foreign Application Priority Data
Dec. 5, 2012 (CN) 201220724073.1

(51) Int. Cl. H01R 13/58

(52) U.S. Cl. CPC H01R 13/58
USPC 439/627

(57) ABSTRACT

An electronic device includes a casing that is formed with a battery slot, positive and negative power output terminals that are disposed in a wall of the battery slot, first and second batteries that are disposed in the battery slot, and a conductive plate that is clamped removably by electrode ends of the first and second batteries. The conductive plate includes a conductive body that has at least one contact for contact with one of the first and second batteries.

### CROSS-REFERENCE TO RELATED APPLICATION

This application claims priority of Chinese Application No. 201220724073.1, filed on Dec. 25, 2012.

### BACKGROUND OF THE INVENTION

1. Field of the Invention

The invention relates to an electronic device, more particularly to a conductive plate and an electronic device having the same.

2. Description of the Related Art

Generally, batteries for a conventional electronic device are directly connected in series between a pair of conductive terminals to obtain a desired voltage. However, due to dust accumulation on electrodes of the batteries, or elastic fatigue of the conductive terminals, the power provided by the batteries may become unstable.

### SUMMARY OF THE INVENTION

Therefore, the object of the present invention is to provide a conductive plate that can overcome the aforesaid drawbacks of the prior art.

Accordingly, a conductive plate of the present invention is adapted for use in an electronic device, the electronic device including a casing that is formed with a battery slot, first and second batteries that are arranged in a stack and that are disposed in the battery slot, positive and negative power output terminals that are disposed in a wall of the battery slot, the first battery having a first electrode end that is connected electrically to a first electrode end of the second battery, second electrode ends of the first and second batteries being connected electrically and respectively to the positive and negative power output terminals, the conductive plate comprising:

a conductive body adapted to be clamped removably by the first electrode ends of the first and second batteries.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a preferred embodiment of an electronic device according to the invention;

FIG. 2 is a perspective view of a conductive plate of the preferred embodiment;

FIG. 3 is another perspective view of the conductive plate of the preferred embodiment;

FIG. 4 is a sectional view of the conductive plate of the preferred embodiment taken along line IV-IV in FIG. 2;

FIG. 5 is a fragmentary enlarged sectional view of the conductive plate of the preferred embodiment;

FIG. 6 is another sectional view of the conductive plate of the preferred embodiment taken along line VI-VI in FIG. 3;

FIG. 7 is another fragmentary enlarged sectional view of the conductive plate of the preferred embodiment;

FIG. 8 is a fragmentary side view of a variation of the conductive plate of the preferred embodiment;

FIG. 9 is a fragmentary side view of another variation of the conductive plate of the preferred embodiment; and

FIG. 10 is a perspective view of still another variation of the conductive plate of the preferred embodiment.

### DETAILED DESCRIPTION OF THE PREFERRED EMBODIMENT

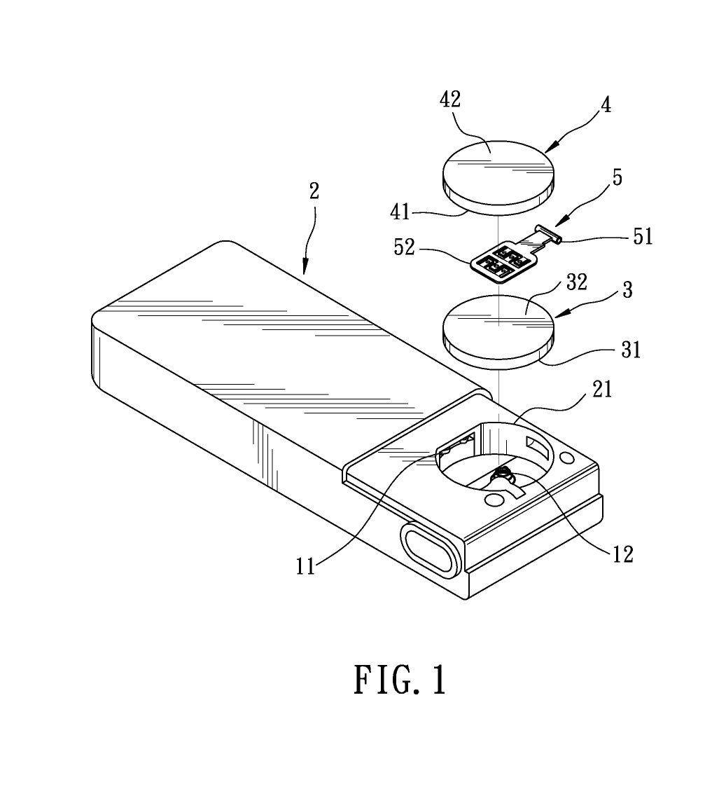

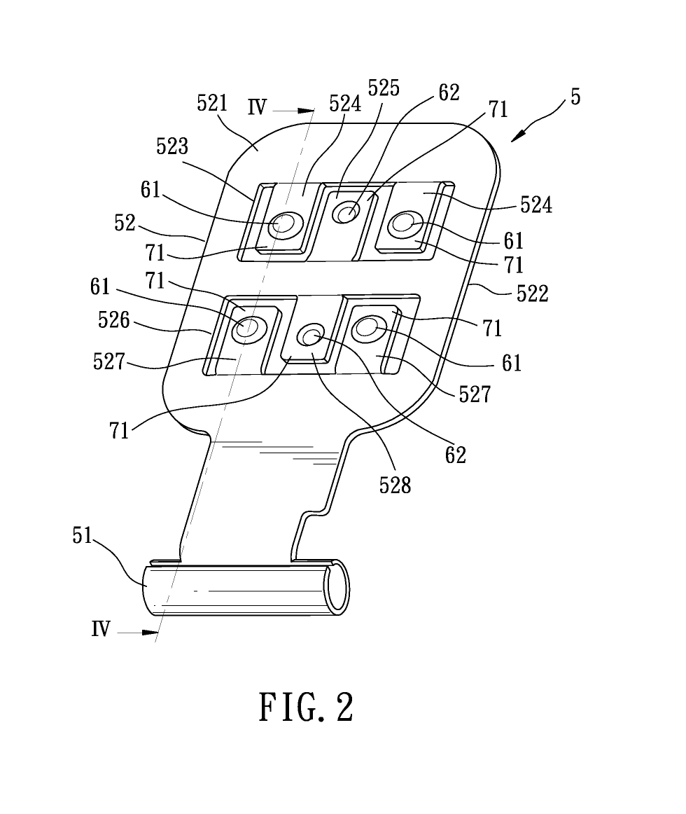

As shown in FIGS. 1 to 3, a preferred embodiment of an electronic device according to the present invention is exemplified as a blood glucose meter, but may be other electronic devices. The electronic device comprises a casing 2 that is formed with a battery slot 21, a first battery 3 that is disposed in the battery slot 21, a second battery 4 that is disposed in the battery slot 21 and that is stacked with the first battery 3, positive and negative power output terminals 11, 12 that are disposed in a wall of the battery slot 21, and a conductive plate 5. The first battery 3 has a first electrode end 32 connected electrically to a first electrode end 41 of the second battery 4. Second electrode ends 31, 42 of the first and second batteries 3, 4 are connected electrically and respectively to the negative and positive power output terminals 12, 11. In this embodiment, the first and second batteries 3, 4 are configured to be button battery cells . Each of the button cells has a top surface and an annular lateral surface that cooperatively serve as a positive terminal (i.e., the first electrode end 32 and the second electrode end 42), and a bottom surface that serves as a negative terminal (i.e., the second electrode end 31 and the first electrode end 41). However, the first and second batteries 3, 4 may be configured to be other type of batteries, for instance, AAA, D, C, AA, N or square.

The conductive plate 5 includes a conductive body 52 that is clamped removably between the first electrode ends 32, 41 of the first and second batteries 3, 4, and a mounting portion 51 that extends from the conductive body 52 and that is adapted to be connected movably to the casing 2. The conductive body 52 has a first surface 521 that faces the first battery 3, a second surface 522 that is opposite to the first surface 521 and that faces the second battery 4, a first through groove 523 that extends through the first and second surfaces 521, 522, a pair of spaced-apart resilient first tongue 524 that are disposed in the first through groove 523, a resilient second tongue 525 that is disposed in the first through groove 523 between the first tongues 524, a second through groove 526 that extends through the first and second surfaces 521, 522 and that is spaced apart from the first through groove 523, a pair of spaced-apart resilient third tongues 527 that are disposed in the second through groove 526, and a resilient fourth tongue 528 that is disposed in the second through groove 526 between the third tongues 527. Each of the first tongues 524 has a free end 71 and a fixed end opposite to the free end 71 and connected fixedly to an edge surrounding the first through groove 523. The second tongue 525 has a free end 71 and a fixed end opposite to the free end 71 and connected fixedly to the edge surrounding the first through groove 523. Each of the third tongues 527 has a free end 71 and a fixed end opposite to the free end 71 and connected fixedly to an edge surrounding the second through groove 526. The fourth tongue 528 has a free end 71 and a fixed end opposite to the free end 71 and connected fixedly to the edge surrounding the second through groove 526. Each of the first tongues 524 and the third tongues 527 defines a part of the first surface 521, each of the second tongue 525 and the fourth tongue 528 defines a part of the second surface 522.

In this embodiment, the conductive plate 5 is connected to the casing 2 by the mounting portion 51. However, the mounting portion 51 may be omitted in other embodiments of the present invention.

The conductive body 52 is made of conductive materials, preferably materials that are not easy to oxidize, such as gold, silver, and nickel, and more preferably a gold-plated metal that has a superior conductivity and a relatively low cost. The mounting portion 51 may be made of the same material of the conductive body 52 and molded with the conductive body 52 as one piece, and may be made of a flexible plastic or a flexible metal.

The conductive body 52 further has four first contacts 61 that are disposed respectively on the first tongues 524 and the third tongues 527, and two second contacts 62 that are disposed respectively on the second tongue 525 and the fourth tongue 528. The numbers of the first and second contacts 61, 62 may vary for different demands. For example, the conductive body 52 of the conductive plate 5 may have only one first contact 61 or only one second contact 62. Moreover, the conductive body 52 of the conductive plate 5 may not be formed with first and second through grooves 523, 526 and the tongues 524, 525, 527, 528, and the first and second contacts 61, 62 may be formed directly on the conductive body 52.

In this embodiment, the conductive body 52 has two through grooves 523, 526 and six tongues 524, 525, 527, 528. However, the numbers of the through grooves 523, 526 and the tongues 524, 525, 527, 528 may vary. The configuration of the through grooves 523, 526 and the tongues 524, 525, 527, 528 enhance the flexibility of the conductive plate 5 to enhance contact between the first contacts 61 and the first battery 3 and contact between the second contacts 62 and the second battery 4.

In this embodiment, the first and second batteries 3, 4 are connected in series, the first contacts 61 are connected to the positive terminal of the first battery 3, and the second contacts 62 are connected to the negative terminal of the second battery 4. However, the first and second batteries 3, 4 may be connected in parallel, e.g., the first and second contacts 61, 62 are connected respectively to the positive terminals of the first and second batteries 3, 4, or connected respectively to the negative terminals of the first and second batteries 3, 4.

In this embodiment, the through grooves 523, 526 are rectangular, the first and second tongues 524, 525 are rectangular and extend in opposite directions, and the third and fourth tongues 527, 528 are rectangular and extend in opposite directions.

While in this embodiment, the electronic device has only two batteries 3, 4 disposed in the battery slot 21, more than two batteries may be employed in other embodiments of this invention with a conductive plate 5 being disposed between each adjacent pair of the batteries.

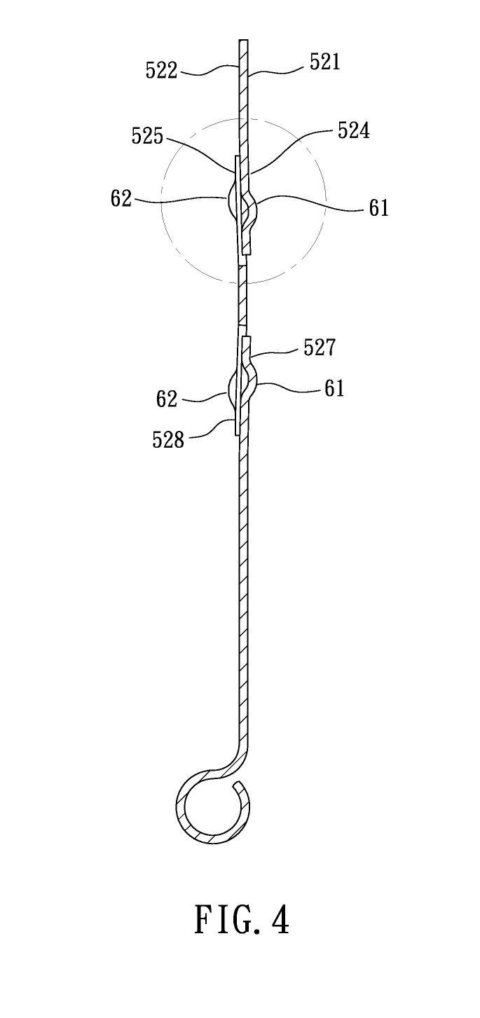

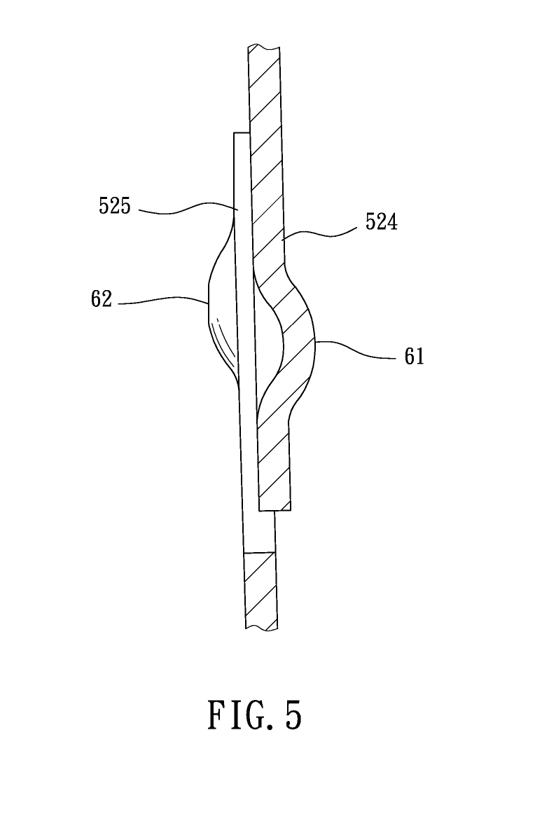

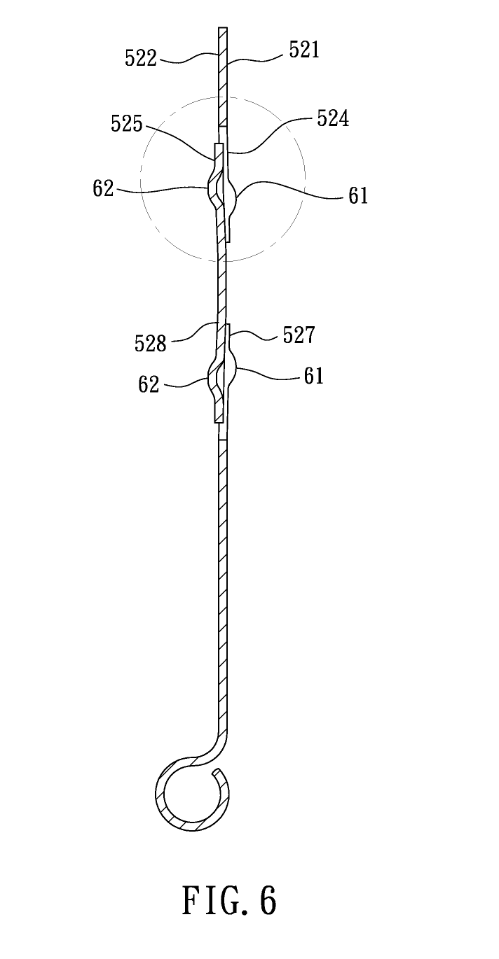

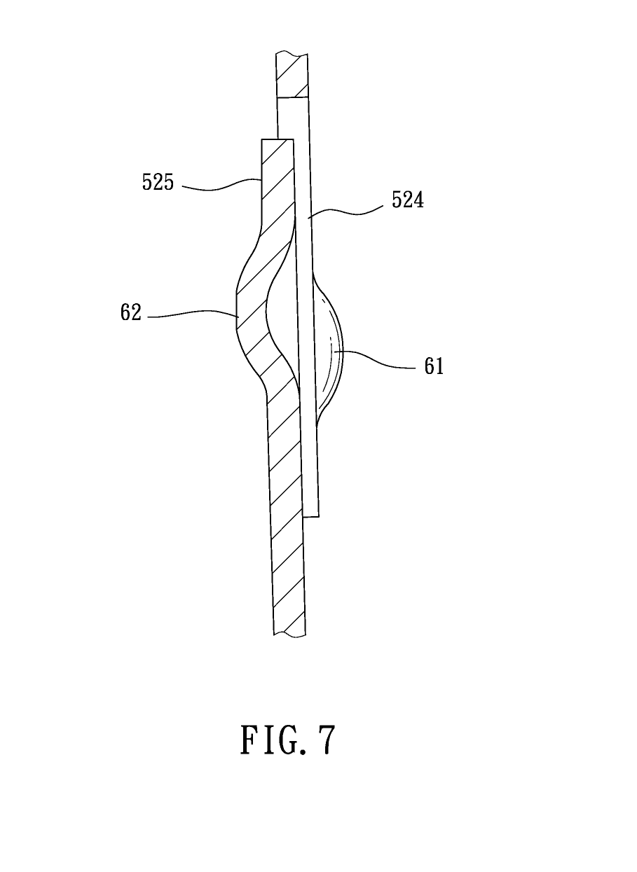

Referring to FIGS. 1, 2, 4 and 5, each first contact 61 is configured as a bulge protruding toward the first battery 3 from the first surface 521. Referring to FIGS. 1, 3, 6 and 7, each second contact 62 is configured as a bulge protruding toward the second battery 4 from the second surface 522. In this embodiment, the conductive plate 5 has a thickness ranging from 0.05 to 0.25 mm, preferably from 0.13 to 0.17 mm. Each of the first and second contacts 61, 62 has a thickness ranging from 0.05 to 0.25 mm, preferably from 0.13 to 0.17 mm. Each of the contacts 61, 62 applies a contact force on a corresponding one of the terminals of the first and second batteries 3, 4 and ranging from 100 to 600 grams, preferably from 200 to 500 grams.

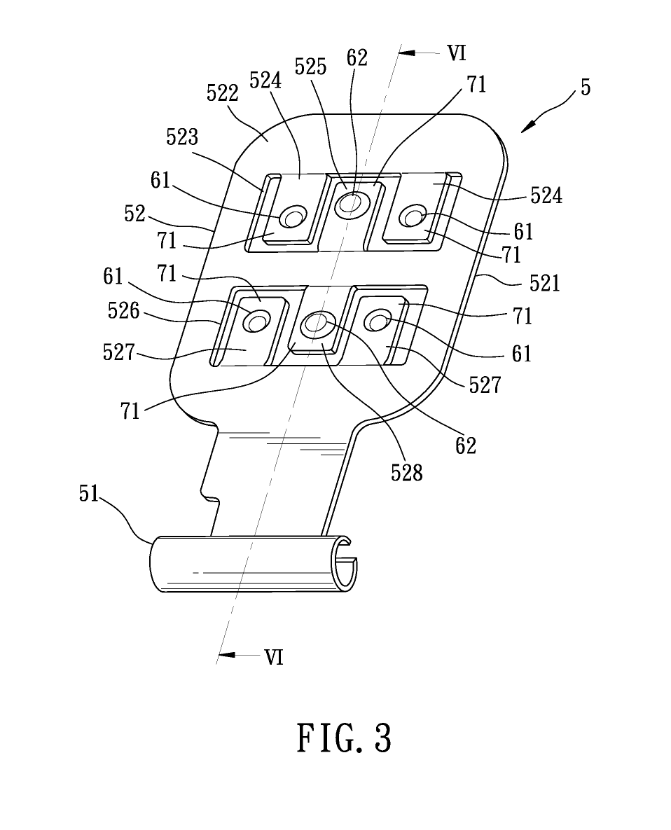

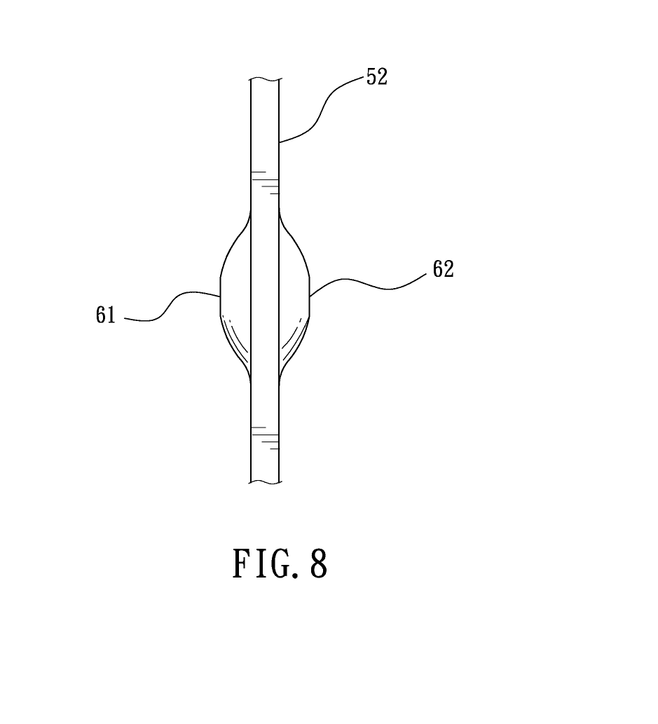

Referring to FIGS. 3 and 8, the first and second contacts 61, 62 may be formed by pressing or injection molding, or may be soldered on the first and second surfaces 521, 522 of the conductive body 52.

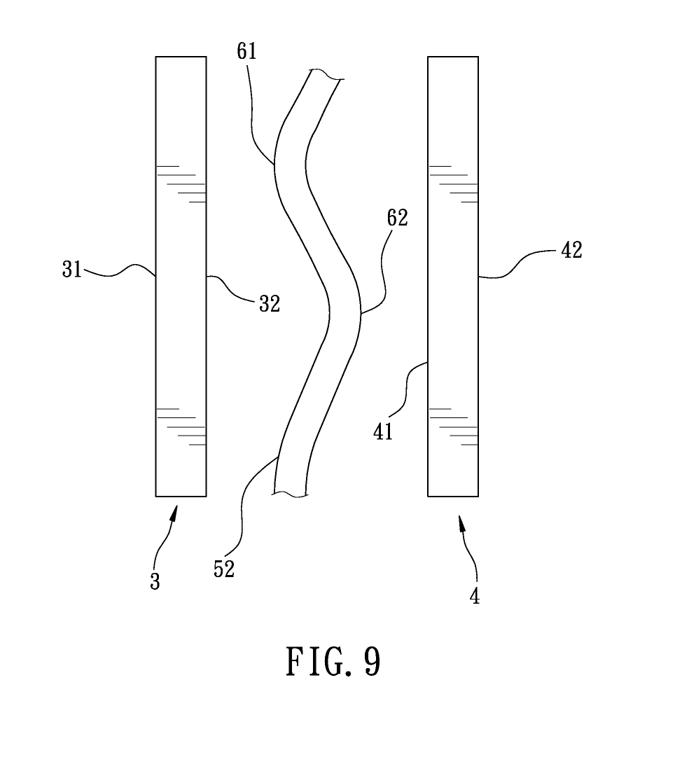

Referring to FIG. 9, a variation of the conductive body 52 is a curved plate. The first contact 61 is configured to be a convex portion of the curved plate to contact the first battery 3, and the second contact 62 is configured to be another convex portion of the curved plate to contact the second battery 4.

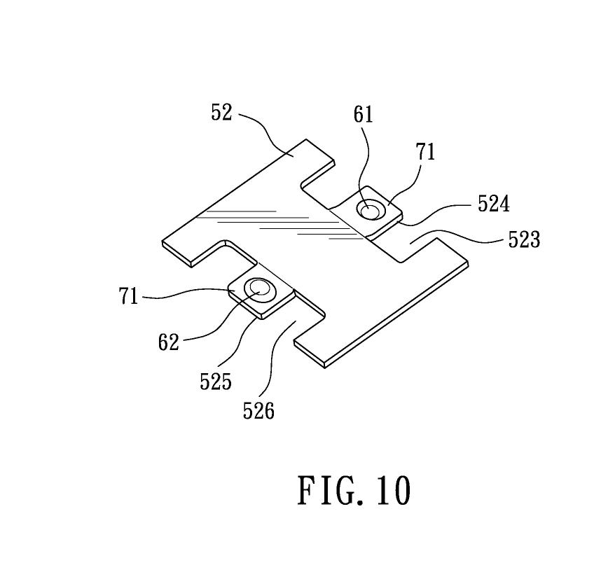

Referring to FIG. 10, another variation of the conductive body 52 is shown. The through grooves 523, 526 are formed respectively in opposite edge portions of the conductive body 52. The tongues 524, 525 extend respectively into the through grooves 523, 526 and are provided respectively with first and second contact 61, 62. Each of the tongues 524, 525 has a free end 71 and a fixed end opposite to the free end 71 connected fixedly to an edge surrounding the corresponding one of the through grooves 523, 526. However, the through grooves 523, 526 can be formed respectively in any edge portions of the conductive body 52, and the numbers of the through grooves 523, 526 and the tongues 524, 525 may vary.

The advantages of this invention are as follows:

1. The conductive body 52 of the conductive plate 5 is disposed between the first and second batteries 3, 4, and each of the first and second contacts 61, 62 has a point contact with one of the first electrode ends 32, 41 of the first and second batteries 3, 4. Therefore, dust accumulation on the first electrode ends 32, 41 of the first and second batteries 3, 4 would not easily affect the electrical connection between the conductive plate 5 and the first and second batteries 3, 4.

2. During installment of the batteries 3, 4, the conductive body 52 is easily positioned between the first and second batteries 3, 4 by pivoting the mounting portion 51.

3. The configuration of the through grooves 523, 526 and the tongues 524, 525, 527, 528 enhance the flexibility of the conductive plate 5, thereby further enhancing the contacts between the first contacts 61 and the first battery 3 and between the second contacts 62 and the second battery 4.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A conductive plate adapted for use in an electronic device, the electronic device including a casing that is formed with a battery slot, first and second batteries that are arranged in a stack and that are disposed in the battery slot, positive and negative power output terminals that are disposed in a wall of the battery slot, the first battery having a first electrode end that is connected electrically to a first electrode end of the second battery, second electrode ends of the first and second batteries being connected electrically and respectively to the positive and negative power output terminals, said conductive plate comprising:
a conductive body adapted to be clamped removably by the first electrode ends of the first and second batteries.

2. The conductive plate as claimed in claim 1, wherein said conductive body has
a first surface that faces the first battery,
a second surface that is opposite to said first surface and that faces the second battery, and
at least one first contact that is disposed on said first surface and that is to be connected electrically to the first battery.

3. The conductive plate as claimed in claim 2, wherein said first contact is configured as a bulge protruding toward the first battery from said first surface.

4. The conductive plate as claimed in claim 2, wherein said conductive body further has
a first through groove that extends through said first and second surfaces, and
a resilient first tongue that has a fixed end connected fixedly to an edge surrounding said first through groove, that has a free end, and that defines a part of said first surface to dispose said first contact.

5. The conductive plate as claimed in claim 2, wherein said conductive body further has
at least one second contact that is disposed on said second surface and that is to be connected electrically to the second battery,
a resilient first tongue that has a free end and that defines a part of said first surface to dispose said first contact, and
a resilient second tongue that has a free end and that defines a part of said second surface to dispose said second contact.

6. The conductive plate as claimed in claim 5, wherein said conductive body further has a first through groove that extends through said first and second surfaces, said first tongue extending into said first through groove and having a fixed end that is connected to an edge surrounding said through groove oppositely of said free end of said first tongue, said second tongue extending into said first through groove at a position spaced apart from said first tongue and having a fixed end that is connected to said edge surrounding said first through groove oppositely of said free end of said second tongue.

7. The conductive plate as claimed in claim 2, wherein said conductive body is a curved plate, said first contact being configured to be a convex portion of said curved plate to contact the first battery.

8. The conductive plate as claimed in claim 1, further comprising a mounting portion that extends from said conductive body and that is adapted to be connected movably to the casing.

9. The conductive plate as claimed in claim 1, wherein said conductive body has
a first through groove,
a pair of spaced-apart resilient first tongue that are disposed in said first through groove, each of which has a fixed end connected fixedly to an edge surrounding said first through groove,
a resilient second tongue that is disposed in said first through groove between said first tongues and that has a fixed end connected fixedly to said edge surrounding said first through groove,
a second through groove that is spaced apart from said first through groove,
a pair of spaced-apart resilient third tongues that are disposed in said second through groove, each of which has a fixed end connected fixedly to an edge surrounding said second through groove,
a resilient fourth tongue that is disposed in said second through groove between said third tongues and that has a fixed end connected fixedly to said edge surrounding said second through groove,
a plurality of first contacts that are connected respectively to said first and third tongues, and
a plurality of second contacts that are connected respectively to said second and fourth tongues.

10. An electronic device comprising:
a casing that is formed with a battery slot;
positive and negative power output terminals that are disposed in a wall of said battery slot;
first and second batteries that are disposed in said battery slot; and
a conductive plate that is clamped removably by an electrode end of said first battery and an electrode end of said second battery; wherein, said first battery is stacked on said second battery, said conductive plate being disposed between said first and second batteries, said first battery having a first electrode end that is connected electrically to a first electrode end of said second battery via said conductive plate, second electrode ends of said first and second batteries being connected electrically and respectively to said positive and negative power output terminals, said conductive plate including a conductive body that has at least one contact for contact with one of said first electrode ends of said first and second batteries.

11. The electronic device as claimed in claim 10, wherein said conductive body of said conductive plate further has
a first surface that faces said first battery,
a second surface that is opposite to said first surface and that faces said second battery, and
a first contact that is disposed on said first surface and that is connected electrically to said first electrode end of said first battery, said first contact being configured as a bulge that protrudes toward the first battery from said first surface.

12. The electronic device as claimed in claim 11, wherein said conductive body of said conductive plate further has
a first through groove that extends through said first and second surfaces, and
a resilient first tongue that has a fixed end connected fixedly to an edge surrounding said first through groove, that has a free end, and that defines a part of said first surface to dispose said first contact.

13. The electronic device as claimed in claim 10, wherein said conductive plate further includes a mounting portion that extends from said conductive body and that is connected movably to said casing.

14. The electronic device as claimed in claim 10, wherein said conductive body of said conductive plate further has
a first through groove,
at least one resilient first tongue that is disposed in said first through groove and that has a fixed end connected fixedly to an edge surrounding said first through groove, and
a resilient second tongue that is disposed in said first through groove, that is spaced apart from said first tongue, and that has a fixed end connected fixedly to said edge surrounding said first through groove.
